(19) United States
(12) Patent Application Publication
(10) Pub. No.: US 2014/0198284 A1
(43) Pub. Date: Jul. 17, 2014

(54) LIQUID CRYSTAL DISPLAY PANEL

(71) Applicant: HannStar Display Corporation, New Taipei City (TW)

(72) Inventors: Chia-Shin WENG, Chiayi City (TW); Wei-Ren LO, Taipei City (TW); Hsien-Tang HU, Taichung City (TW)

(73) Assignee: HannStar Display Corporation, New Taipei City (TW)

(21) Appl. No.: 14/020,879

(22) Filed: Sep. 8, 2013

(30) Foreign Application Priority Data
Jan. 11, 2013 (CN) 201310011257.2

(51) Int. Cl. G02F 1/1335

(52) U.S. Cl. CPC G02F 1/133514
USPC 349/106

(57) ABSTRACT

A liquid crystal display panel includes a color filtering substrate and an array substrate. The color filtering substrate includes a plurality of first spacers and a plurality of second spacers. The array substrate includes a plurality of cavities disposed on a surface of the array substrate facing the color filtering substrate. The cavities are disposed corresponding to the second spacers. The first spacers are physically connected to the array substrate, and the second spacers are physically spaced apart from the array substrate.

### RELATED APPLICATIONS

This application claims priority to China Application Serial Number 201310011257.2, filed Jan. 11, 2013, which is herein incorporated by reference.

### BACKGROUND

1. Field of Invention

The present invention relates to a liquid crystal display panel.

2. Description of Related Art

Liquid crystal displays (LCDs) have been widely used in electrical products in recent times due to the rapid progress of optical technology and semiconductor technology. Moreover, with the advantages of high image quality, compact size, light weight, low driving voltage, and low power consumption, LCDs have been introduced into portable computers, personal digital assistants, and color televisions, and are gradually replacing the cathode ray tubes (CRTs) used in conventional displays. As a result, LCDs have become the most widely used display apparatus.)

The liquid crystal display panel includes the main elements of a TFT substrate, a color filter, and a liquid crystal layer sandwiched therebetween. The thickness and the uniformity of the liquid crystal layer affect the characteristics of the liquid crystal display panel, such as display frequency, viewing angle, brightness, and contrast ratio. Therefore there is a need to maintain the distance between the substrates. However, with the development of touch display modules, it is common for the liquid crystal display panel to be pressed during operation. In order to maintain the distance between the substrates, a design of forming spacers with different heights on the color filter is utilized. With the use of such a design, when the TFT substrate is packaged with the color filter, only some of the spacers touch the TFT substrate, and the other spacers with a shorter height are not in contact with the TFT substrate to thereby provide extra support when an external force is applied to the liquid crystal display panel.

However, different products have their own design considerations, and as a result, such a solution of changing the height of the spacers complicates the design process.

### SUMMARY

The present disclosure provides a liquid crystal display panel which reduces the complexity of product design.

An aspect of the invention provides a liquid crystal display panel, which includes a color filtering substrate and an array substrate. The color filtering substrate includes a plurality of first spacers and a plurality of second spacers. The array substrate includes a lower substrate, a plurality of thin film transistors disposed on the lower substrate, an over coat layer disposed on the thin film transistors, a passivation layer disposed on the over coat layer, a common electrode layer disposed between the over coat layer and the passivation layer, and a pixel electrode layer disposed on the passivation layer and respectively connected to the thin film transistor. The array substrate includes a plurality of cavities disposed on a surface of the array substrate facing the color filtering substrate. The cavities are disposed corresponding to the second spacers. The first spacers are physically connected to the array substrate, and the second spacers are physically spaced apart from the array substrate.

In one or more embodiments, the passivation layer is made of an organic photoresist or an inorganic insulating material.

In one or more embodiments, the over coat layer s made of an organic photoresist.

In one or more embodiments, the over coat layer includes a plurality of depressions, the passivation layer is disposed on the over coat layer, and the cavities are defined by the depressions.

In one or more embodiments, the common electrode layer includes a plurality of openings for exposing the depressions.

In one or more embodiments, the size, shape, and position of the openings are designed according to a target capacitance.

In one or more embodiments, a part of the common electrode layer is disposed on a surface of the over coat layer forming the depressions.

In one or more embodiments, a distance from a upper surface of the over coat layer to a upper surface of the lower substrate is substantially uniform over the entire area of the upper surface of the over coat layer, and the passivation layer includes the cavities.

In one or more embodiments, the cavities are extended to the over coat layer, the common electrode layer includes a plurality of openings, and the cavities are arranged in the openings.

In one or more embodiments, a depth of the cavities is 0.3 μm to 1.0 μm.

In one or more embodiments, the height of the first spacers and the height of the second spacers are substantially the same.

In one or more embodiments, the color filter substrate comprises a plurality of shielding regions, and the first spacers and the second spacers are to formed on the shielding regions.

In one or more embodiments, the first spacers and the second spacers are made of an organic photoresist.

In one or more embodiments, the color filter substrate comprises a plurality of pixel regions, the over coat layer has a first thickness at positions corresponding to the pixel regions, and a second thickness at positions corresponding to the second spacers wherein the first thickness is greater than the second thickness, and a thickness difference between the first thickness and the second thickness is 0.3 μm to 1.0 μm.

In one or more embodiments, there is no common electrode layer under the second spacers.

In one or more embodiments, the color filter substrate comprises a plurality of pixel regions, the passivation layer has a third thickness at positions corresponding to the pixel regions, and a fourth thickness at positions corresponding to the second spacers, wherein the third thickness is greater than the fourth thickness, and a thickness difference between the third thickness and the fourth thickness is 0.3 μm to 1.0 μm.

In one or more embodiments, the common electrode layer is covered by the passivation layer and is not in direct contact with the pixel electrode layer.

In one or more embodiments, the color filtering substrate comprises a transparent conductive layer.

In one or more embodiments, the color filtering substrate comprises a transparent organic photoresist layer.

In one or more embodiments, the array substrate comprises an insulating layer.

The first spacers and the second spacers in this liquid crystal display panel have substantially the same height. The second spacers are not directly in contact with the array substrate due to the cavities formed on the surface of the array substrate. Thus, when there is an external force applied on the liquid crystal display panel and the liquid crystal display panel is displaced, the second spacers come to touch the array substrate, thereby providing extra support and cushioning. The first spacers and the second spacers have substantially the same height. Therefore, the design and fabricating process of the color filtering substrate need not be changed, and the complexity associated with developing a product can be reduced.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 to FIG. 7 are cross-sectional views of different embodiments of a liquid crystal display panel of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

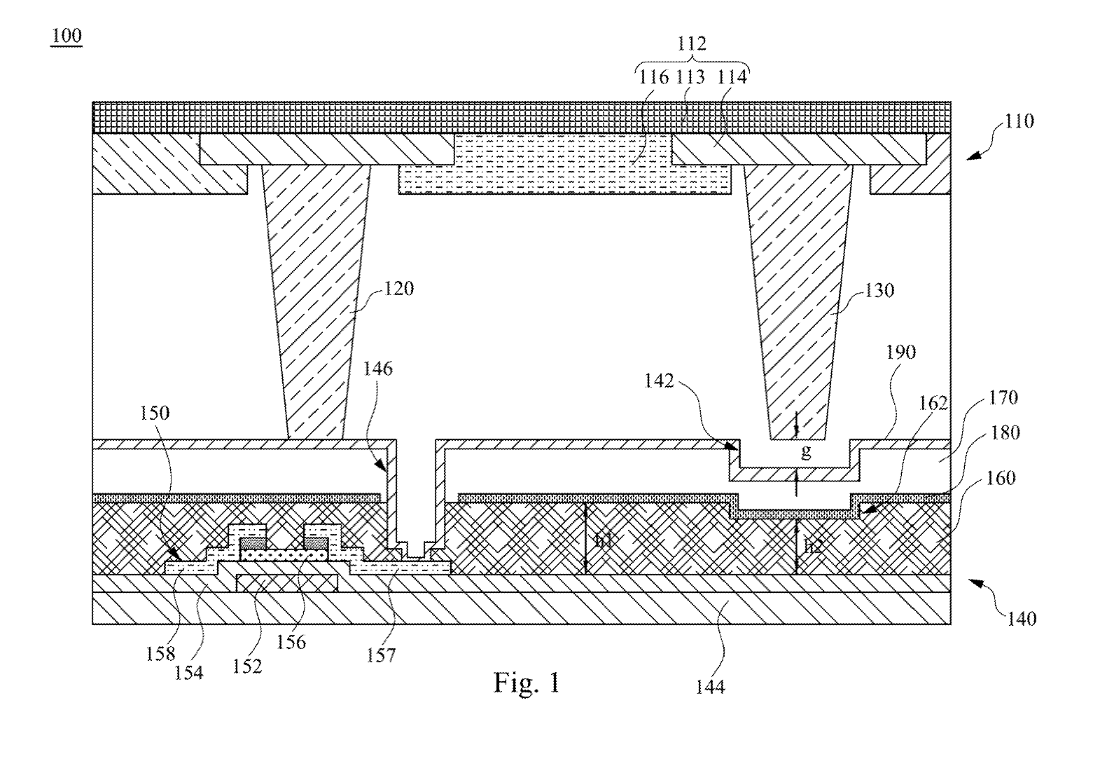

FIG. 1 is a cross-sectional view of a first embodiment of a liquid crystal display panel of the invention. The liquid crystal display 100 includes a color filtering substrate 110 and an array substrate 140. The color filtering substrate 110 comprises a plurality of first spacers 120 and a plurality of second spacers 130. The height of the first spacers 120 and the height of the second spacers 130 are substantially the same. The array substrate 140 comprises a plurality of cavities 142 disposed at a surface of the array substrate 140 facing the color filtering substrate 110. The cavities 142 are disposed corresponding to the second spacers 130. As a result of this configuration, the first spacers 120 are physically connected to the array substrate 140, and the second spacers 130 are physically spaced apart from the array substrate 140 when the color filtering substrate 110 is packaged with the array substrate 140. As a result, when there is an external force applied to the liquid crystal panel 100, the second spacers 130 are displaced to be put in physical contact with the array substrate 140 to thereby provide extra support and cushioning.

To describe the structure of the liquid crystal display 100 in greater detail, the color filtering substrate 110 comprises a color filter 112. The first spacers 120 and the second spacers 130 are disposed on a surface of the color filter 112 facing the array substrate 140. The color filter 112 comprises a upper substrate 113, a plurality of shielding regions 114 and a plurality of pixel regions 116. The pixel regions 116 are arranged between the shielding regions 114.

The upper substrate 113 can be a glass substrate. The shielding regions 114 can be a black matrix. The pixel regions 116 can be formed by injecting color photoresists into the spaces between the shielding regions 114 after the shielding regions 114 are formed. The first spacers 120 and the second spacers 130 are then formed on the shielding regions 114. The first spacers 120 and the second spacers 130 can be made of an organic photoresist. The material of the first spacers 120 and the second spacers 130 can be the same. The height of the first spacers 120 and the height of the second spacers 130 are substantially the same. The first spacers 120 and the second spacers 130 are made during the same process and are made by the same photo mask. The sectional profile of the first spacers 120 and the second spacers 130 is trapezoidal. The width of the first spacers 120 and the second spacers 130 is gradually decreased from the color filter 112 toward the array substrate 140.

The array substrate 140 can be a thin film transistor substrate. The array substrate 140 comprises a lower substrate 144, a plurality of thin film transistors 150 disposed on the lower substrate 144, an over coat layer 160 disposed on the thin film transistors 150, a passivation layer 170 disposed on the over coat layer 160, a common electrode layer 180 disposed between the over coat layer 160 and the passivation layer 170, and a pixel electrode layer 190 disposed on the passivation layer 170. The array substrate 140 has a plurality of through holes 146, such that the pixel electrode layer 190 can be connected to the thin film transistors 150 respectively via the through holes 146. The pixel electrode layer 190 is not in contact with the common electrode layer 180.

The lower substrate 144 can be a glass substrate. Each of the thin film transistors 150 includes a gate electrode 152 disposed on the lower substrate 144, a gate insulating layer 154 disposed on the gate electrode 152 and the lower substrate 144, a channel layer 156 disposed on the gate insulating layer 154, and a drain 157 and a source 158 connected to the channel layer 156. The channel layer 157 is disposed above the gate electrode 152. The gate electrode 152 is connected to a scan line (not shown). The pixel electrode layer 190 is connected to the drain 157, and the source 158 is connected to a data line (not shown).

The over coat layer 160 is disposed on the thin film transistors 150. In this embodiment, the over coat layer 160 is formed by a half tone mask to thereby provide different heights to the over coat layer 160. As a result, a plurality of depressions 162 can be formed on the over coat layer 160 during the same process used for forming the over coat layer 160 (i.e., during the same photo mask process). More particularly, the depressions 162 are arranged corresponding to the second spacers 130, and a width of the depression 162 is equal to or greater than a width of an end of the second spacers 130 connected to the color filter 112. The over coat layer 160 has a second thickness h2 at positions corresponding to the second spacers 130, and a first thickness h1 at positions corresponding to the pixel regions 116. The first thickness h1 is greater than the second thickness h2, and a thickness difference between the first thickness h1 and the second thickness h2 is 0.3 μm to 1.0 μm.

The common electrode layer 180 is continuously disposed on the over to coat layer 160 (i.e., in a continuous manner without any breaks), such that the common electrode layer 180 is also continuously disposed on the surface of the over coat layer 160 forming the depressions 162. The passivation layer 170 is uniformly formed on the common electrode layer 180. In some embodiments, the passivation layer 170 and the over coat layer 160 can be made of the same material, such as an organic photoresist. In other embodiments, the passivation layer 170 and the over coat layer 160 can be made of different materials. For example, the over coat layer 160 can be made of an organic photoresist while the passivation layer 170 is made of an inorganic insulation material, or the over coat layer 160 and the passivation layer 170 may be made of different types of organic photoresists.

Due to the depressions 162 formed on the surface of the over coat layer 160 facing the color filtering substrate 110, the cavities 142 can be defined by the array substrate 140 when the common electrode layer 180, the passivation layer 170, and the pixel electrode layer 190 are formed in this order on the over coat layer 160. The depth of the cavities 142 is substantially equal to the depth of the depressions 162 of the over coat layer 160. Stated differently, the depth of the cavities 142 is substantially equal to the thickness difference between the first thickness h1 and the second thickness h2, which is about 0.3 μm to 1.0 μm.

The pixel electrode layer 190 is formed on the passivation layer 170 and is connected to the thin film transistors 150 respectively via the through holes 146. The pixel electrode layer 190 is not connected to the common electrode layer 180 for preventing a short circuit. When the color filtering substrate 110 is packaged with the array substrate 140, the first spacers 120 physically touch to the pixel electrode layer 190, and the second spacers 130 are spaced apart from the pixel electrode layer 190 to thereby form a gap g between the second spacers 130 and the pixel electrode layer 190. The gap g is provided by the cavities 142, and the gap g is about 0.3 μm to 1.0 μm.

The first spacers 120 and the second spacers 130 in this liquid crystal display panel 100 have substantially the same height. The second spacers 130 are not directly in contact with the array substrate 140 due to the cavities 142 formed on the surface of the array substrate 140. Thus, when there is an external force applied on the liquid crystal display panel 100 and the liquid crystal display panel 100 is displaced, the second spacers 130 come to touch the array substrate 140, thereby providing extra support and cushioning. The first spacers 120 and the second spacers 130 have substantially the same height. Therefore, the design and fabricating process of the color filtering substrate 110 need not be changed, and the complexity associated with developing a product can be reduced.

Details of the array substrate 140 and the color filtering substrate 110 have been described above with respect to the first embodiment. In the following embodiments, only the differences will discussed, and a description of aspects thereof that are the same as those of the first embodiment will not be repeated.

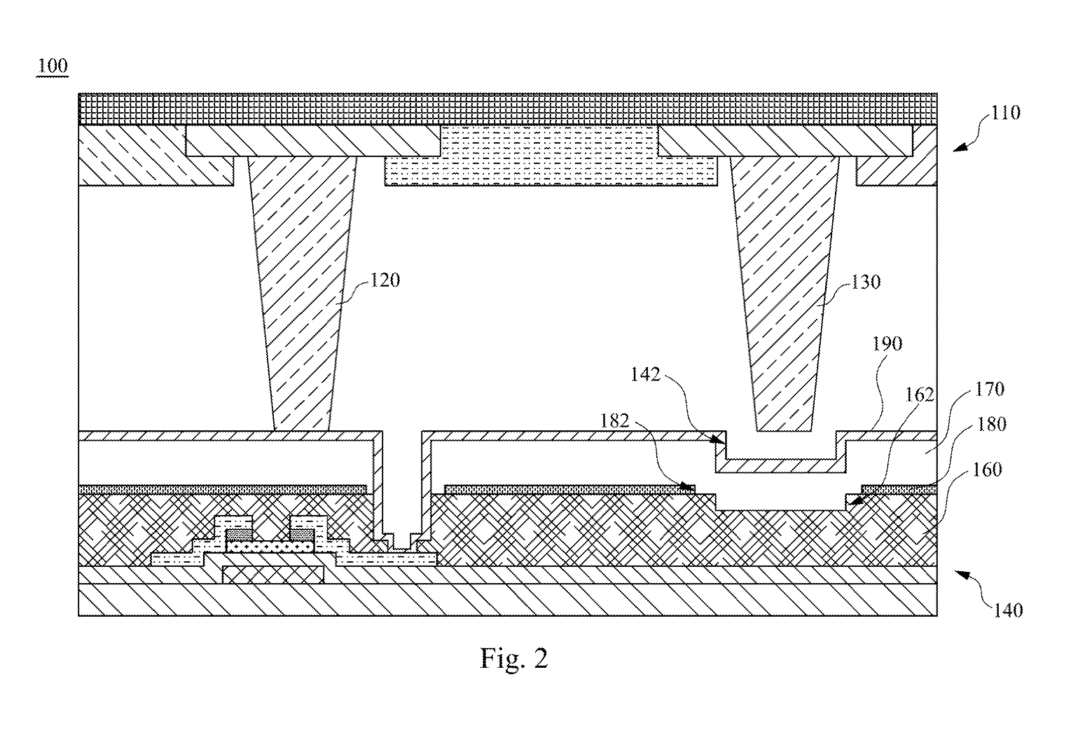

FIG. 2 is a cross-sectional view of a second embodiment of the liquid crystal display panel 100 of the invention. The difference between the second embodiment and the first embodiment is that a common capacitance of the liquid crystal display panel 100 can be adjusted by changing the design of the pattern of the common electrode layer 180. The common electrode layer 180 may comprise a plurality of openings 182. The size, shape, and position of the openings 182 can be designed according to a target capacitance. For example, the openings 182 of the common electrode layer 180 can be positioned corresponding to the second spacers 130, thereby exposing the depressions 162 via the openings 182. Subsequently, the passivation layer 170 and the pixel electrode layer 190 are formed on the over coat layer 160 and the common electrode layer 180 sequentially. There is no common electrode layer 180 under the second spacers 130.

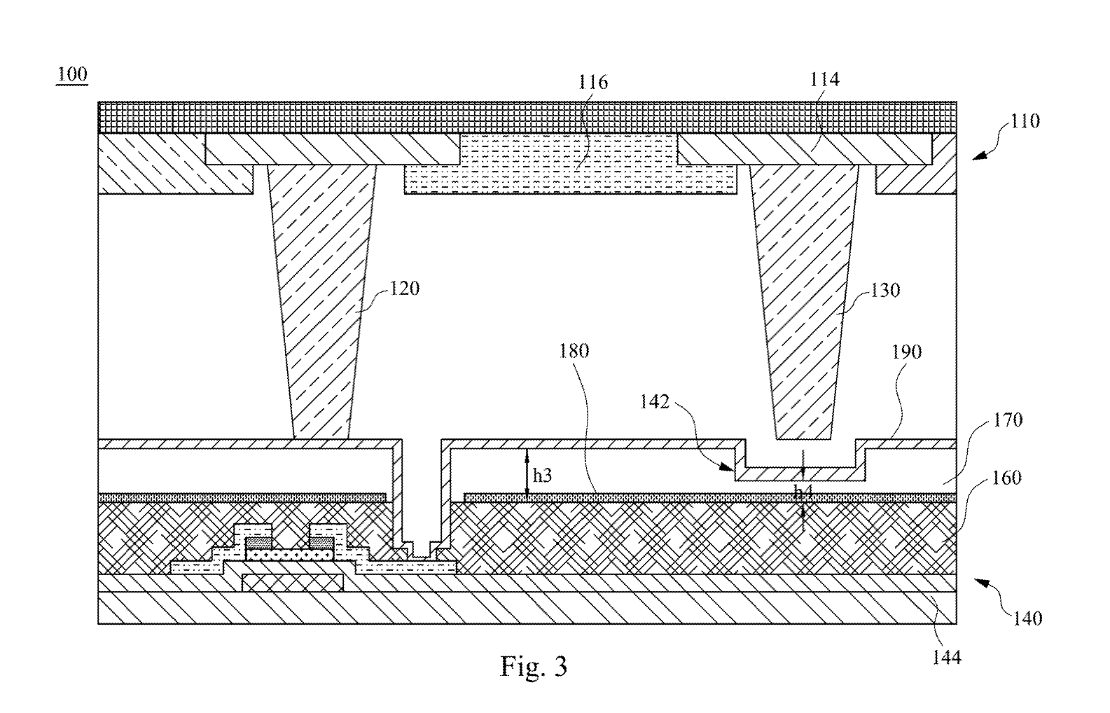

FIG. 3 is a cross-sectional view of a third embodiment of the liquid crystal display panel 100 of the invention. In this embodiment, the distance from the upper surface of the over coat layer 160 to the upper surface of the lower substrate 144 is substantially uniform over the entire area of the upper surface of the over coat layer 160. The upper surface of the over coat layer 160 which faces the second spacers 130 of the color filtering substrate 110 is a flat surface. The passivation layer 170 is made of an organic photoresist. The passivation layer 170 may have different etching depths by using half tone mask, thereby forming the cavities 142 on the passivation layer 170 directly. The common electrode layer 180 can be continuously arranged under the cavities 142, as shown in FIG. 3. In other embodiments, the common electrode layer 180 can be a segmented pattern with openings 182 (as shown in FIG. 2). The passivation layer 170 has a fourth thickness h4 at positions corresponding to the second spacers 130. The passivation layer 170 has a third thickness h3 at positions corresponding to the pixel regions 116. The third thickness h3 is larger than the fourth thickness h4, and a height difference between the third to thickness h3 and the fourth thickness h4 is about 0.3 μm to 1.0 μm.

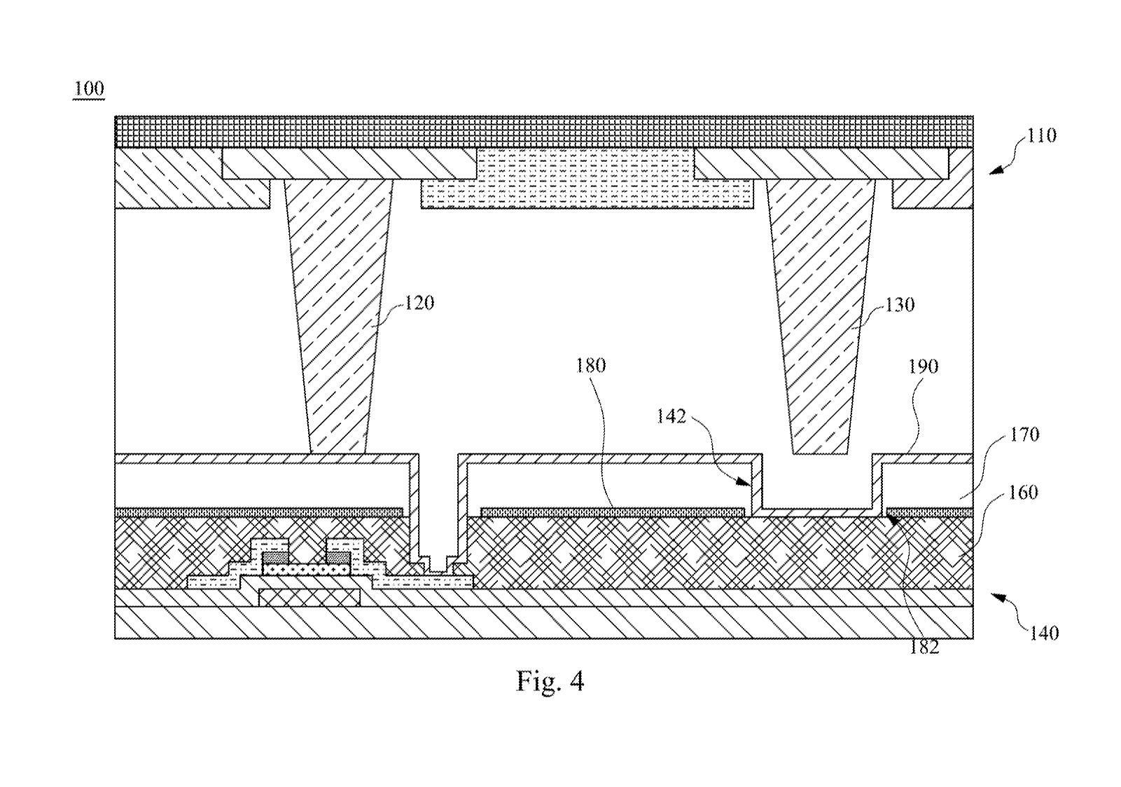

FIG. 4 is a cross-sectional view of a fourth embodiment of the liquid crystal display panel 100 of the invention. In this embodiment, the passivation layer 170 is made of an organic photoresist. The cavities 142 may be extended to the over coat layer 160 to form through holes passing through the passivation layer 170 by an etching process. The pixel electrode layer 190 covers the passivation layer 170 and parts of the over coat layer 160 exposed by the cavities 142. In order to prevent a short circuit caused by the pixel electrode layer 190 directly touching the common electrode layer 180, the common electrode layer 180 comprises plural openings 182. The cavities 142 are located in the openings 182. The size of the openings 182 of the common electrode layer 180 is greater than the size of the cavities 142, such that the common electrode layer 180 can be covered by the passivation layer 170 and is not in direct contact with the pixel electrode layer 190.

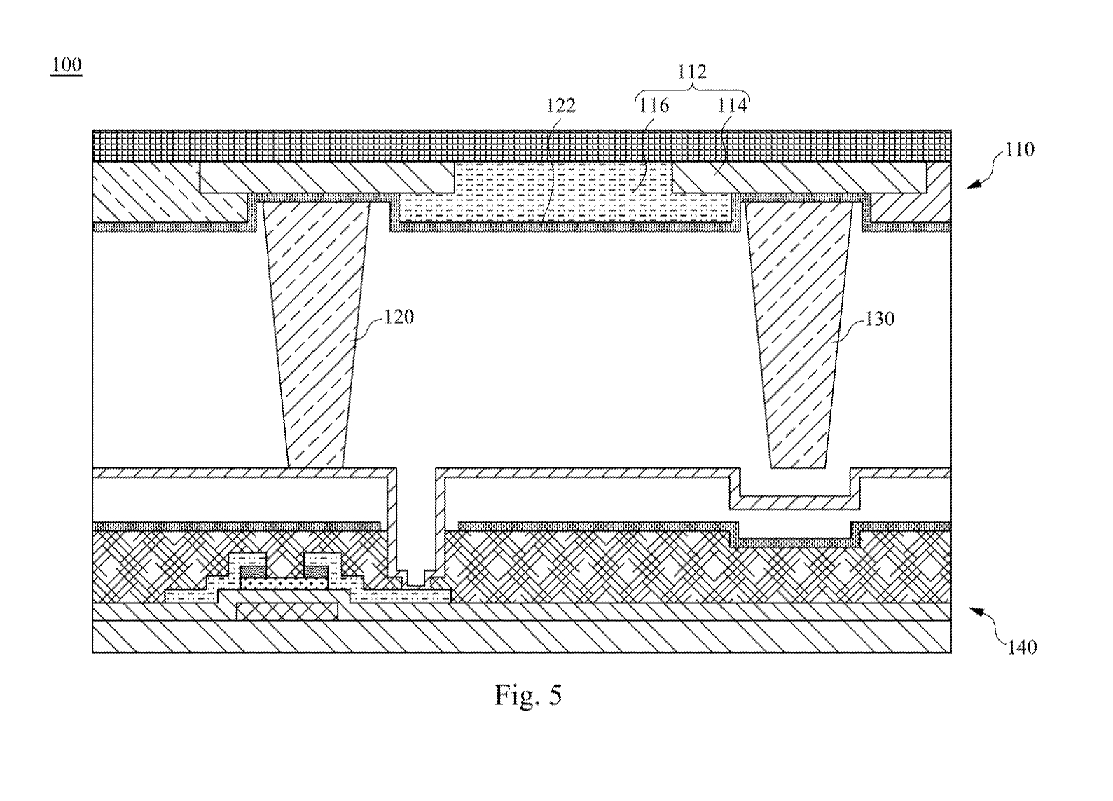

FIG. 5 is a cross-sectional view of a fifth embodiment of the liquid crystal display panel 100 of the invention. The color filtering substrate 110 may optionally comprise a transparent conductive layer 122. The transparent conductive layer 122 can be formed on the surface of the color filter 112 facing the array substrate 140 and is disposed between the color filter 112 and the first and second spacers 120, 130. The design of the cavities 142 can be the same as in any one of the embodiments disclosed in FIG. 1 to FIG. 4.

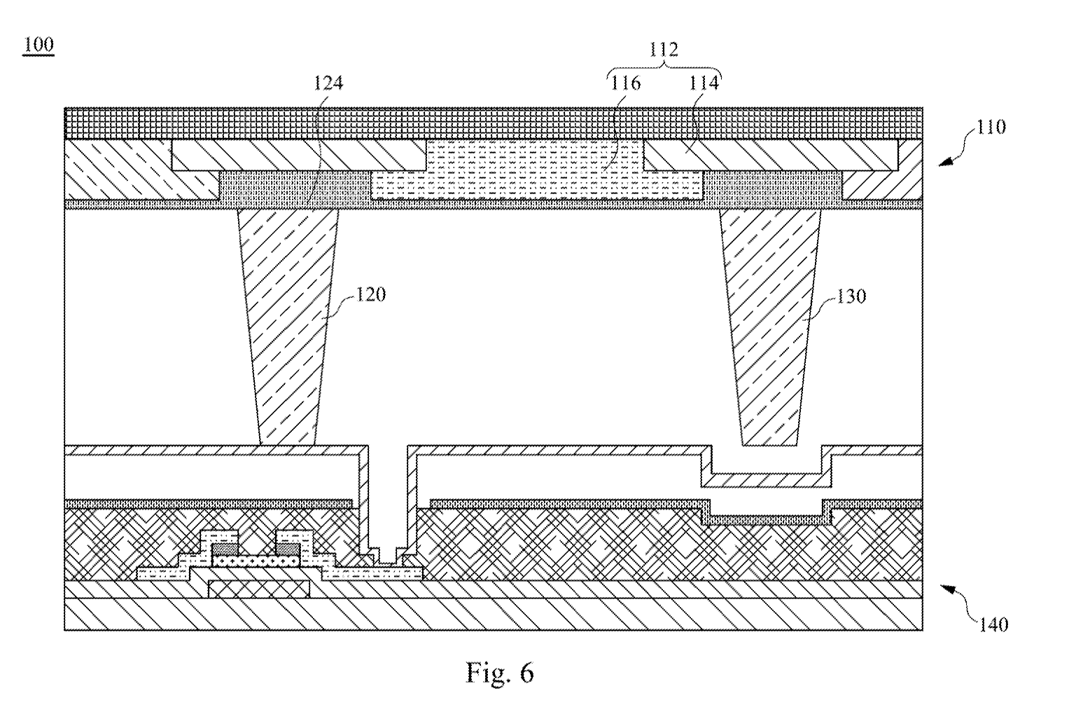

FIG. 6 is a cross-sectional view of a sixth embodiment of the liquid crystal display panel of the invention. The color filtering substrate 110 may optionally comprise a transparent organic photoresist layer 124. The transparent organic photoresist layer 124 can be formed on the surface of the color filter 112 facing the array substrate 140 and is disposed between the color filter 112 and the first and second spacers 120, 130. The transparent organic photoresist layer 124 is utilized for filling and flattening the surface of the color filter 112, so that an amount of injected liquid crystal and the distance between the color filtering substrate 110 and the array substrate 140 can be easily controlled. The design of the cavities 142 can be the same as in any one of the embodiments disclosed in FIG. 1 to FIG. 4.

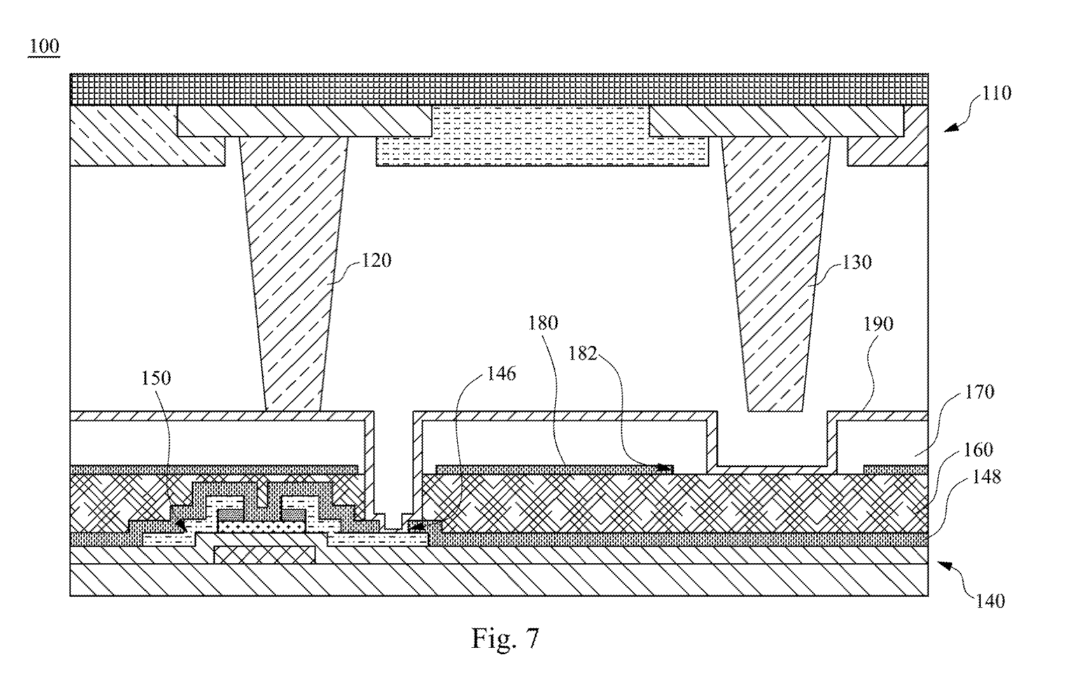

FIG. 7 is a cross-sectional view of a seventh embodiment of the liquid crystal display panel 100 of the invention. The array substrate 140 may optionally comprise an insulating layer 148. The insulating layer 148 is formed on the thin film transistors 150 and is disposed between the thin film transistors 150 and the over coat layer 160. The insulating layer 148 includes a plurality of through holes 146, so that the pixel electrode layer 190 can connect to the thin film transistors 150 respectively via the through holes 146. The design of the cavities 142 can be the same as in any one of the embodiments disclosed in FIG. 1 to FIG. 4.

The above embodiments of the present disclosure have the following advantages. The first spacers and the second spacers in this liquid crystal display panel have substantially the same height. The second spacers are not directly in contact with the array substrate due to the cavities formed on the surface of the array substrate. Thus, when there is an external force applied on the liquid crystal display panel and the liquid crystal display panel is displaced, the second spacers come to touch the array substrate, thereby providing extra support and cushioning. The first spacers and the second spacers have substantially the same height. Therefore, the design and fabricating process of the color filtering substrate need not be changed, and the complexity associated with developing a product can be reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel comprising:
a color filtering substrate comprising a plurality of first spacers and a plurality of second spacers; and
an array substrate comprising:
a lower substrate;
a plurality of thin film transistors disposed on the lower substrate;
an over coat layer disposed on the thin film transistors;
a passivation layer disposed on the over coat layer;
a common electrode layer disposed between the over coat layer and the passivation layer; and
a pixel electrode layer disposed on the passivation layer and connected to each of the thin film transistors,
wherein the array substrate comprises a plurality of cavities disposed on a surface of the array substrate facing the color filtering substrate, the cavities are disposed corresponding to the second spacers, the first spacers are physically connected to the array substrate, and the second spacers are physically spaced apart from the array substrate.

2. The liquid crystal display panel of claim 1, wherein the passivation layer is made of an organic photoresist or an inorganic insulating material.

3. The liquid crystal display panel of claim 1, wherein the over coat layer is made of an organic photoresist.

4. The liquid crystal display panel of claim 1, wherein the over coat layer comprises a plurality of depressions, the passivation layer is disposed on the over coat layer, and the cavities are defined by the depressions.

5. The liquid crystal display panel of claim 4, wherein the common electrode layer comprises a plurality of openings for exposing the depressions.

6. The liquid crystal display panel of claim 5, wherein a size, shape, and position of the openings are designed according to a target capacitance.

7. The liquid crystal display panel of claim 4, wherein a part of the common electrode layer is disposed on a surface of the over coat layer forming the depressions.

8. The liquid crystal display panel of claim 1, wherein a distance from a upper surface of the over coat layer to a upper surface of the lower substrate is substantially uniform over the entire area of the upper surface of the over coat layer, and the passivation layer comprises the cavities.

9. The liquid crystal display panel of claim 8, wherein the cavities are extended to the over coat layer, the common electrode layer comprises a plurality of openings, and the cavities are arranged in the openings.

10. The liquid crystal display panel of claim 1 wherein a depth of the cavities is 0.3 μm to 1.0 μm.

11. The liquid crystal display panel of claim 1, wherein the height of the first spacers and the height of the second spacers are substantially the same.

12. The liquid crystal display panel of claim 1, wherein the color filter substrate comprises a plurality of shielding regions, and the first spacers and the second spacers are formed on the shielding regions.

13. The liquid crystal display panel of claim 12, wherein the first spacers and the second spacers are made of an organic photoresist.

14. The liquid crystal display panel of claim 1, wherein the color filter substrate comprises a plurality of pixel regions, the over coat layer has a first thickness at positions corresponding to the pixel regions, and a second thickness at positions corresponding to the second spacers, wherein the first thickness greater than the second thickness, and a thickness difference between the first thickness and the second thickness is 0.3 μm to 1.0 μm.

15. The liquid crystal display panel of claim 1, wherein there is no common electrode layer under the second spacers.

16. The liquid crystal display panel of claim 1, wherein the color filter substrate comprises a plurality of pixel regions, the passivation layer has a third thickness at positions corresponding to the pixel regions, and a fourth thickness at positions corresponding to the second spacers, wherein the third thickness is greater than the fourth thickness, and a thickness difference between the third thickness and the fourth thickness is 0.3 μm to 1.0 μm.

17. The liquid crystal display panel of claim 1, wherein the common electrode layer is covered by the passivation layer and is not in direct contact with the pixel electrode layer.

18. The liquid crystal display panel of claim 1, wherein the color filtering substrate comprises a transparent conductive layer.

19. The liquid crystal display panel of claim 1, wherein the color filtering substrate comprises a transparent organic photoresist layer.

20. The liquid crystal display panel of claim 1, wherein the array substrate comprises an insulating layer.
